(19) United States
(12) Patent Application Publication
(10) Pub. No.: US 2006/0168601 A1
(43) Pub. Date: Jul. 27, 2006

(54) Optical disc apparatus

(76) Inventors: Hideyuki Onuma, Urayasu (JP); Seiji Hamaie, Ebina (JP); Sojiro Kirihara, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/190,841

(22) Filed: Jul. 28, 2005

(30) Foreign Application Priority Data
Jan. 25, 2005 (JP) 2005-016956

(51) Int. Cl. G11B 17/04

(52) U.S. Cl. 720/619

(57) ABSTRACT

In order to decrease the total thickness of an optical disc apparatus the optical disc apparatus is provided with a structure in which an optical disc contacts the surface of a top cover facing the optical disc so that the top end surface of a cylindrical protruding clamper inserted into the center hole of the optical disc protrudes from a through hole of the top cover and is positioned higher than the flat upper surface of the top cover in the disc flat surface area over the disc, while the optical disc is being chucked.

### BACKGROUND OF THE INVENTION

The present invention relates in general to an optical disc apparatus for recording or reproducing information on or from an optical disc, and, more particularly, the invention relates to a technique which is useful for reducing the thickness of an optical disc apparatus.

Known technologies in the field of the present invention are disclosed JP-A-2002-352497 and JP-A-2004-39198, for example. A small-sized thin disc apparatus is disclosed in JP-A-2002-352497, in which a turn table is shifted by a shifting mechanism relative to a contact member provided in an upper casing. Then, a disc holding mechanism is inserted into the center hole of the disc by pressing the disc surface against the contact member surface, so that the disc is laid (chucked) on the turn table. A disc drive apparatus is disclosed in JP-A-2004-39198, which also includes a chucking mechanism in which a disc spindle mounted on a turn table can be set into and released from a disc. In this mechanism, the disc spindle is brought close to the disc so as to press the disc against an upper case, and the disc is chucked on the turn table due to the reaction against this pressing action.

### SUMMARY OF THE INVENTION

In both of the above-described apparatuses, while a disc is being chucked, the top end surface of the clamper, which represents the portion to be inserted into the center hole of the disc, does not protrude above the height of an outside flat surface of the cover (top cover), but is positioned below the height of the cover. Thus, it is difficult to reduce the height of the cover, and, therefore, it is difficult to decrease the overall thickness of the apparatus if the height of the top end of the clamper inserted into the center hole of the disc is not reduced. However, when the height of the top end surface of the clamper that is inserted into the center hole of the disc is decreased, the difficulty in inserting the clamper into the center hole of the disc may increase, or other problems which prevent secure chucking of the disc may occur.

Therefore, a problem that the invention is designed to solve is to provide a slot-in type optical disc apparatus in which a disc recording medium is directly inserted into the apparatus without using a tray or a case or other type of holder, wherein the apparatus includes a top cover having a lowered flat surface so as to decrease the thickness of the apparatus, but is capable of chucking an optical disc with a predetermined chucking reliability.

In order to solve this problem, it is an object of the present invention to provide an optical disc apparatus having a thickness of 9.5×10⁻³ m or smaller, for example.

For achieving this object, an optical disc apparatus according to the present invention has a structure in which an optical disc contacts the surface of the top cover which is facing the optical disc so that a cylindrical protrusion at the end surface of the clamper, which is inserted into a center hole of the optical disc to keep the optical disc from moving in a radial direction, protrudes from a through hole in the top cover and is positioned above the height of the upper flat surface of the top cover in a disc flat surface area, while the optical disc is being chucked.

### BRIEF DESCRIPTION OF THE DRAWINGS

The present invention will be described with reference to the accompanying drawings, wherein:

FIG. 1 is a perspective view which illustrates the structure of an optical disc apparatus, with the cover removed, representing an embodiment according to the present invention;

FIG. 2 is a plan view showing the inside structure of the optical disc apparatus shown in FIG. 1;

FIG. 3 is a diagrammatic side view which illustrates the chucking of an optical disc in the optical disc apparatus shown in FIG. 1; and

FIG. 4 is a diagrammatic side view which illustrates the chucking of an optical disc in a known optical disc apparatus.

### DETAILED DESCRIPTION OF THE PREFERRED EMBODIMENTS

A preferred embodiment according to the present invention will be described with reference to the drawings.

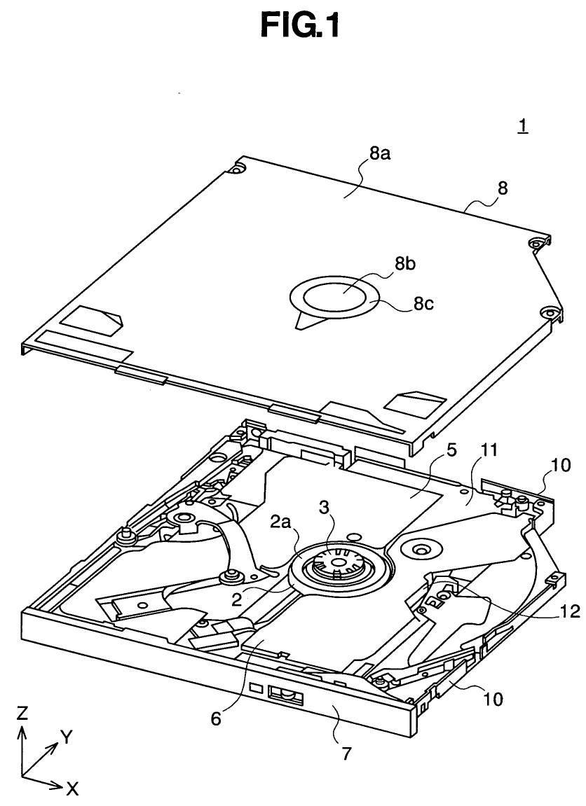

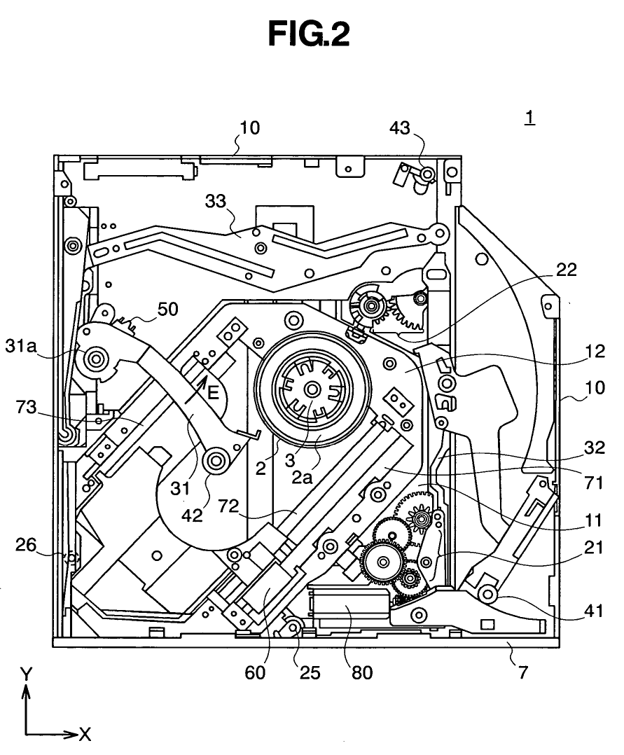

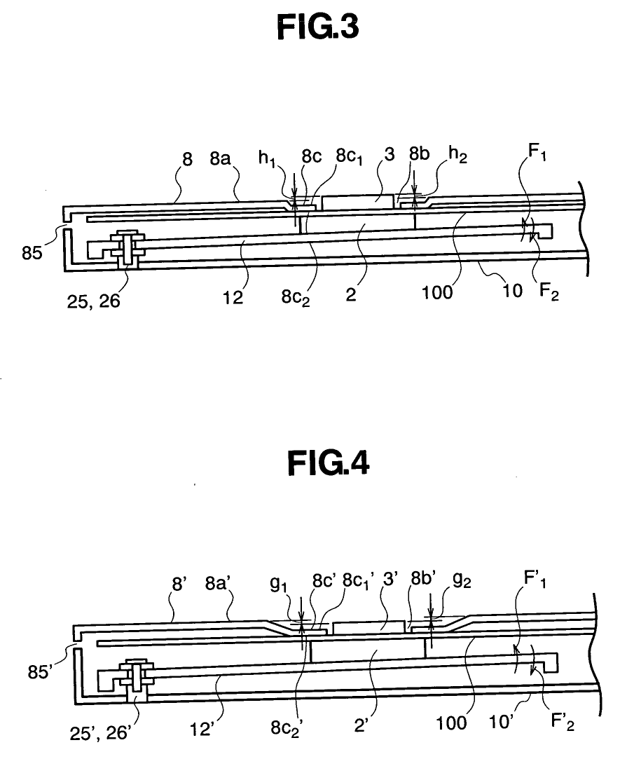

FIGS. 1 through 3 illustrate an embodiment according to the present invention, wherein: FIG. 1 is a perspective view showing the structure of a slot-in type optical disc apparatus with the top cover removed therefrom, representing an embodiment according to the present invention; FIG. 2 is a plan view showing the inside structure of the optical disc apparatus shown in FIG. 1; and FIG. 3 illustrates the chucking of an optical disc in the optical disc apparatus shown in FIG. 1.

As shown in FIG. 1, the optical disc apparatus 1 has a disc motor 2 for rotating an optical disc (not shown); a central protrusion clamper 3 mounted on the rotating shaft of the disc motor 2, comprising a central cylindrical protrusion which is inserted into a center hole of the optical disc to keep the optical disc from moving in a radial direction while the optical disc is being chucked; a disc flat surface supporting member 2a, which is also provided on the rotating shaft of the disc motor 2 concentrically with the clamper 3 to support the flat surface of the optical disc around the center hole (i.e., the flat surface where recording and reproducing are performed), with the clamper 3 inserted into the center hole of the optical disc; inside covers 5, 6 which cover a wide area around the disc motor 2, the clamper 3, the disc flat surface supporting member 2a and other parts within the apparatus to separate the space for the flat surface of the optical disc from the space for components and mechanisms in that area; a front panel 7 of the optical disc apparatus 1; a top cover 8 disposed above the clamper 3 to cover the front side of the optical disc apparatus 1; a flat surface 8a of the top cover 8 facing the outside (outside flat surface); a through hole 8b provided on the top cover 8 at the position of the clamper 3; a concave portion 8c formed around the through hole 8b; a bottom cover 10 for covering the back side of the optical disc apparatus 1; a base 11 serving as a first base to be coupled to the bottom cover 10; and a unit mechanical deck 12 serving as a second base to which the disc motor 2, the clamper 3, the disc flat surface supporting member 2a, an optical pickup (not shown) and other components are attached.

Shown in FIG. 2 are: a lead screw member 71 which, when rotating a screw (not shown) on its surface, shifts the optical pickup (not shown) in substantially the radial direction of the optical disc (not shown); a feed motor 60 for rotating the lead screw member 71; guide members 72 and 73 for guiding the movement of the optical pickup; levers 31, 32 and 33, which transmit driving power for inserting the optical disc into the apparatus through the front panel 7 and for discharging the optical disc from the apparatus through the front panel 7; a fulcrum member 31a which is used for the rotation of the lever 31; rollers 41, 42 and 43 for centering the optical disc by contacting the outside circumferential surface of the optical disc; a motor 80; a switch 50 for turning on and off the supply of driving input to the motor 80; a transmission mechanism 21 for transmitting rotational driving force form the motor 80 to the lever 32; a raising and lowering mechanism 22 provided on the first base 11 to raise and lower the unit mechanical deck 12 after the optical disc is inserted into a predetermined position within the apparatus, when the optical disc is to be chucked; and fulcrums 25, 26 for the upward/downward movement of the unit mechanical deck 12.

Reference numerals shown in FIG. 2 other than those mentioned above refer to similar components shown in FIG. 1. Since the feed motor 60, the lead screw member 71, the guide members 72 and 73 and other components are mounted on the unit mechanical deck 12, those components are also raised and lowered with the upward and downward movement of the unit mechanical deck 12. The transmitting mechanism 21 has a row of gears. The roller 42 is disposed on the lever 31.

In the structure shown in FIGS. 1 and 2, when the optical disc is inserted into the apparatus to be chucked, the raising and lowering mechanism 22 raises the unit mechanical deck 12, which is the second base, to bring the optical disc into contact with the face of the concave portion 8c of the top cover 8 facing the disc. In this condition, the top end surface of the clamper 3 protrudes from the through hole 8b of the top cover 8 so that the top surface of the clamper 3 is higher than the outside flat surface 8a of the top cover 8 at least in the disc flat surface area (area overlapping the flat surface of the optical disc).

In the optical disc apparatus 1 having the above-described structure, when the optical disc is inserted from an inlet/outlet (not shown) formed on the front panel 7, the rollers 41, 42 and 43 contact the outside circumferential surface of the optical disc in this order and center the optical disc while displacing the levers 31, 32 and 33. Thus, the optical disc is positioned so as to be substantially concentric with the rotational shaft of the disc motor 2. Simultaneously, the roller 42, which is pressed by the outside circumference of the optical disc, rotates the lever 31 in a direction indicated by an arrow E around the fulcrum on a fulcrum member 31a. When the lever 31 is rotated in the direction of the arrow E by a predetermined amount, the switch 50 is turned on, and a driving circuit (not shown) supplies predetermined driving input to the motor 80 to rotate the motor 80.

The rotational driving force generated by the rotation of the motor 80 is transmitted to the lever 32 through the transmission mechanism 21. The lever 32 transmits the force thus received to the raising and lowering mechanism 22. The raising and lowering mechanism 22, operating in response to the force thus transmitted, provides a rotational force around the fulcrums 25, 26 to the unit mechanical deck 12, pressing the unit mechanical deck 12 at the point where they contact or conducting another action to rotationally displace (raise) the unit mechanical deck 12 in a direction toward the top cover 9. When the unit mechanical deck 12 is raised, the disc motor 2, the clamper 3, and the disc flat surface supporting member 2a are raised with the upward movement of the unit mechanical deck 12. Then, in response to this movement, the protruding clamper 3 is inserted into the center hole of the optical disc, bringing, for example, part of the disc flat surface around the center hole into contact with supporting member 2a. When the unit mechanical deck 12 is further raised in this condition, the optical disc contacts the face of the concave portion 8c of the top cover 8 opposed to the disc. Simultaneously, the clamper 3 enters into the center hole of the optical disc almost completely by the reaction force from the opposed face of the concave portion 8c, bringing the entire circumference, for example, of the disc flat surface supporting member 2a into contact with the flat surface around the center hole of the optical disc.

In this way, the optical disc is chucked by the clamper 3 and the disc flat surface supporting member 2a. While the optical disc is being chucked, the top end surface of the clamper 3 protrudes from the through hole 8b of the top cover 8 so as to be higher than the outside flat surface 8a of the top cover 8 in the disc flat surface area.

When the chucking process is completed, the raising and lowering mechanism 22 rotates the unit mechanical deck 12 around the fulcrums 25 and 26 in the direction opposite to the upward movement direction to lower the unit mechanical deck 12 in response to the driving input to the motor 80. By the downward movement of the unit mechanical deck 12, the optical disc is separated from the face of the concave portion 8c of the top cover 8 facing the disc and is lowered to a predetermined position. In this embodiment, in the condition where the optical disc is lowered to the predetermined position, the top end surface of the clamper 3 is lower than the outside flat surface 8a of the top cover 8 in the disc flat surface area. The driving input to the motor 80 is in an off condition while the optical disc is at the predetermined lowered position, and the optical disc is rotated by the disc motor 2 so that information can be recorded on or reproduced from the optical disc.

Reference numerals similar to those used in FIGS. 1 and 2 are used to identify similar components of the optical disc apparatus 1 in the following description.

FIG. 3 illustrates a condition where an optical disc is chucked in the optical disc apparatus 1.

Shown in FIG. 3 are: an optical disc 100; a surface 8c₁ of the concave portion 8c of the top cover 8 on the side opposite from the optical disc 100 (hereinafter referred to as the outside flat face of the concave portion 8c of the top cover 8); a surface 8c₂ of the concave portion 8c of the top cover 8 facing the optical disc 100 (hereinafter referred to as the inside flat surface of the concave portion 8c of the top cover 8); an inlet/outlet 85 provided on the front panel 7; an arrow F₁ indicating the direction in which the unit mechanical deck 12 is rotated in order to be raised; an arrow F₂ indicating the direction in which the unit mechanical deck 12 is rotated to be lowered; a distance h₁ between the top end surface of the clamper 3 and the outside flat surface 8a of the top cover 8 in the portion of the disc flat surface area that is on the same side as the fulcrums 25 and 26 relative to the center of the unit mechanical deck 12 (i.e., the distance h₁ corresponds to the amount by which the top end surface of the clamper 3 projects from the outside flat surface 8a); and a distance h₂ between the top end surface of the clamper 3 and the outside flat surface 8a of the top cover 8 in the portion of the disc flat surface area that is on the opposite side from the fulcrums 25 and 26 with respect to the center of the unit mechanical deck 12 (i.e., the distance h₂ corresponds to the amount by which the top end surface of the clamper 3 projects from the outside flat surface 8a; h₂ is made to be >h₁).

When the unit mechanical deck 12 is raised by the raising and lowering mechanism 22, the optical disc 100 contacts the inside flat surface 8c₂ of the concave portion 8c of the top cover 8. Then, the clamper 3 enters into the center hole of the optical disc 100 almost completely by the reaction force from the inside flat surface 8c₂, bringing the entire circumference, for example, of the disc flat surface supporting member 2a (not shown in FIG. 3) disposed on the rotating shaft of the disc motor 2 into contact with the flat surface around the center hole of the optical disc 100. While the optical disc 100 is chucked in this manner, the top end surface of the clamper 3 protrudes from the through hole 8b of the top cover 8 so as to be located in a position h₁ to h₂ that is higher than the height of the outside flat surface 8a of the top cover 8 in the disc flat surface area. This structure is provided by decreasing the height of the top cover 8 so that the outside flat surface 8a is lower than the top end surface of the clamper 3. For example, when the distances h₁ and h₂ are 0.5×10⁻³ m or smaller, the entire thickness of the optical disc apparatus 1 can be decreased to 9.5×10⁻³ m or smaller.

FIG. 4 illustrates a condition where the optical disc 100 is chucked in a conventional slot-in type optical disc apparatus for comparison with the structure according to the invention shown in FIG. 3. When the optical disc 100 is chucked in the structure shown in FIG. 4, a unit mechanical deck 12′ is rotated around fulcrums 25′ and 26′ in the direction indicated by an arrow F₁′ and is raised. Then, the optical disc 100 comes into contact with an inside flat surface 8c₂′ of a concave portion 8c′ of a top cover 8′ and is chucked thereby. While the optical disc 100 is being chucked, the top end surface of a clamper 3′ protrudes from a through hole 8b′ of the top cover 8′, but does not go above the height of an outside flat surface 8a′ of the top cover 8′ in the disc flat surface area. That is, the top end surface of the clamper 3′ is located in a position g₁ to g₂ that is lower than the height of the outside flat surface 8a′. In this structure, it is difficult to reduce the height of the top cover 8′ and to decrease the thickness of the entire apparatus. Other components shown in FIG. 4 are: the outside flat surface 8c₁′ of the concave 8c′ of the top cover 8′; the through hole 8b′ formed on the top cover 8′; a bottom cover 10′; an inlet/outlet 85′; and an arrow F₂′ indicating a direction in which the unit mechanical deck 12′ is rotated around the fulcrums 25′ and 26′ in order to be lowered.

In this embodiment according to the present invention, a predetermined height of the top end surface of the clamper 3 is secured such that the optical disc 100 can be securely chucked, even in the case where the height of the flat surface of the top cover 8 is lowered. As a result, the thickness of the apparatus can be further decreased.

While a slot-in type optical disc apparatus is considered by way of example in the above-described embodiment, the invention is obviously applicable to other types of optical disc apparatus.

As described above, an optical disc apparatus according to the present invention has a reduced thickness, but is capable of securely chucking an optical disc.

What is claimed is:

1. An optical disc apparatus which chucks an optical disc concentrically with the rotational shaft of a disc motor and rotates the optical disc so as to record and reproduce information, comprising:
a cylindrical protruding clamper which is provided on the rotating shaft of the disc motor and is inserted into a center hole of the optical disc to keep the optical disc from moving in a radial direction while the optical disc is chucked;
a disc flat surface supporting member provided on the rotating shaft of the disc motor concentrically with the clamper to support a flat surface of the optical disc with the clamper inserted into the center hole of the optical disc;
a top cover which is provided above the clamper to cover the front side of the apparatus and has a through hole in a position opposed to the clamper;
a bottom cover to cover the back side of the apparatus;
a first base coupled to the bottom cover; and
a second base to which at least the disc motor is attached;
a raising and lowering mechanism provided on the first base to raise and lower the second base after the optical disc is inserted into a predetermined position within the apparatus when the optical disc is to be being chucked, wherein:
the raising and lowering mechanism raises the second base and brings the optical disc into contact with the surface of the top cover facing the optical disc so that when the optical disc is being chucked, the top end surface of the clamper protrudes from the through hole of the top cover and is positioned higher than the flat upper surface of the top cover in the disc flat surface area over the disc.

2. An optical disc apparatus as set forth in claim 1, wherein the raising and lowering mechanism lowers the second base and separates the optical disc from the surface of the top cover facing the optical disc so that the optical disc is rotatable, providing a disposition in which the top end surface of the clamper is positioned below the flat surface of the top cover in the disc flat surface area.

3. An optical disc apparatus as set forth in claim 1, wherein the second base moves up by rotating around its fulcrum end which is the end opposite to that where the disc motor is attached with respect to the center of the second base.

4. An optical apparatus as set forth in any one of claims 1 through 3, wherein the distance between the outside surface of the top cover and the outside surface of the bottom cover is 9.5×10⁻³ m or smaller.
